(19) United States
(12) Patent Application Publication
(10) Pub. No.: US 2008/0232882 A1
(43) Pub. Date: Sep. 25, 2008

(54) Printed Medium Management Apparatus

(75) Inventors: Hiroshi KOIE, Nagoya-shi (JP); Masashi SUZUKI, Nagoya-shi (JP); Hideo UENO, Nagoya-shi (JP); Kazunari TAKI, Nagoya-shi (JP); Takahiro IKENO, Seto-shi (JP); Takahiro HOSOKAWA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/857,803

(22) Filed: Sep. 19, 2007

(30) Foreign Application Priority Data
Sep. 19, 2006 (JP) 2006-252990

(51) Int. Cl. B41J 11/44

(52) U.S. Cl. 400/76

(57) ABSTRACT

A printed medium management apparatus includes: a controller that outputs print data generated from file data, and outputs tag data comprising search data including a search word; a print unit that prints an image based on the print data on a recording medium equipped with a non-contact tag; a data recording unit that records the tag data on the non-contact tag; and a search unit that wirelessly communicates with a plurality of non-contact tags, on which search words are recorded by the data recording unit, to search for a non-contact tag on which an inputted search word is recorded.

### CROSS-REFERENCE TO RELATED APPLICATION

This application claims priority from Japanese Patent Application No. 2006-252990, filed on Sep. 19, 2006, the entire subject matter of which is incorporated herein by reference.

### TECHNICAL FIELD

Aspects of the present invention relate to a printed medium management apparatus which prints an image on a sheet equipped with a non-contact tag and which searches a non-contact tag from among a plurality of non-contact tags by wirelessly communicating with them.

### BACKGROUND

JP-A-2004-310293 discloses a printed medium management apparatus which manages a sheet equipped with a non-contact tag capable of communicating wirelessly. In this management apparatus, an image is printed on a sheet equipped with a non-contact tag; and printed medium information, such as a person who performs printing, an objective of printing, and a title, is recorded (written) in the non-contact tag as tag data during printing. Further, distribution information, such as a distributor, the owner of a printed medium, the date and time of distribution, and the location of distribution, is recorded as tag data into the non-contact tag at the time of distribution of a printed medium.

Printed medium information, such as a printing person, and distribution information, such as a distributor, are read from non-contact tags of all sheets stored in a storage space, such as indoor file cabinets. The thus-read printed medium information and the distribution information are written into a search table of a search unit, such as a personal computer. The search unit specifies a non-contact tag corresponding to an input search word based on the printed medium information, such as a person who performs printing, and the distribution information, such as a distributor, which are written into the search table. The position of a sheet is displayed by displaying the position of the non-contact tag; for example, by turning on a lamp provided at the storage space of the sheet equipped with that non-contact tag, or by displaying the storage space of sheets in a virtual space appearing on a screen or the personal computer.

JP-A-2005-196263 discloses an apparatus in which a portable terminal is used as search unit and in which the portable terminal is provided with a camera as well as with a transmission antenna and a plurality of receiving antennas. A corresponding non-contact tag is searched, and the direction of the searched non-contact tag is obtained using the directivity of the plurality of receiving antennas. The position of the searched non-contact tag is displayed on an image captured with a camera by photographing an area in the direction of the non-contact tag.

In the above described apparatuses, when the tag data stored in the non-contact tag correspond to the printed medium information, such as a person who performs printing operation, an objective of printing, and a title, and the distribution information, such as a distributor, the owner of a printed medium, the date and time of distribution, and the location of distribution, a search is performed by taking these pieces of information as clues at the time of a search. A search cannot be performed while printed contents are taken as clues. In order to enable performance of a search by taking printed contents as clues, it is conceivable to store printed contents as tag data, as well.

However, in the case where printed contents are also stored as tag data and where any of the sheets is searched, when tag data are read from a plurality of non-contact tags, the amount of data becomes large, and transferring of data from the respective non-contact tags takes much time. Further, there has been a problem of a search based on the tag data also involving consumption of much time.

Aspects of the present invention relate to the above problem. According to at least one aspect of the present invention, a printed medium management apparatus may be provided which easily performs searching within a short time period.

An aspect of the present invention provides a printed medium management apparatus includes a controller that outputs print data generated from file data, and outputs tag data comprising search data including a search word; a print unit that prints an image based on the print data on a recording medium equipped with a non-contact tag; a data recording unit that records the tag data on the non-contact tag; and a search unit that wirelessly communicates with a plurality of non-contact tags, on which search words are recorded by the data recording unit, to search for a non-contact tag on which an inputted search word is recorded.

### BRIEF DESCRIPTION OF THE DRAWINGS

In the accompanying drawings;

FIG. 1 is a perspective view showing the appearance of a multifunction device according to an embodiment of the present invention;

FIG. 2 is a perspective view of the multifunction device with a reading unit of the present embodiment being opened;

FIG. 3 is a side cross-sectional view of the multifunction device of the present embodiment when viewed from an axial direction of a feed roller;

FIG. 4 is a block diagram showing an electrical system of the multifunction device of the present embodiment;

FIG. 5 is a descriptive view showing the general configuration of a printed medium management apparatus of the present embodiment;

FIG. 6 is a block diagram showing an electrical system of a portable search terminal of the present embodiment;

FIG. 7 is a block diagram showing an electrical system of a non-contact tag of the present embodiment;

FIG. 8 is a schematic view showing a storage area of nonvolatile RAM of the non-contact tag of the present embodiment;

FIG. 9 is a flowchart showing an example of print control processing performed by a personal computer of the present embodiment;

FIG. 10 is a flowchart showing example print/write processing performed by the multifunction device of the present embodiment; and

FIG. 11 is a flowchart showing example search control processing performed by the search portable terminal of the present embodiment.

### DETAILED DESCRIPTION

One illustrative embodiment according to the present invention will be described with reference to the drawings.

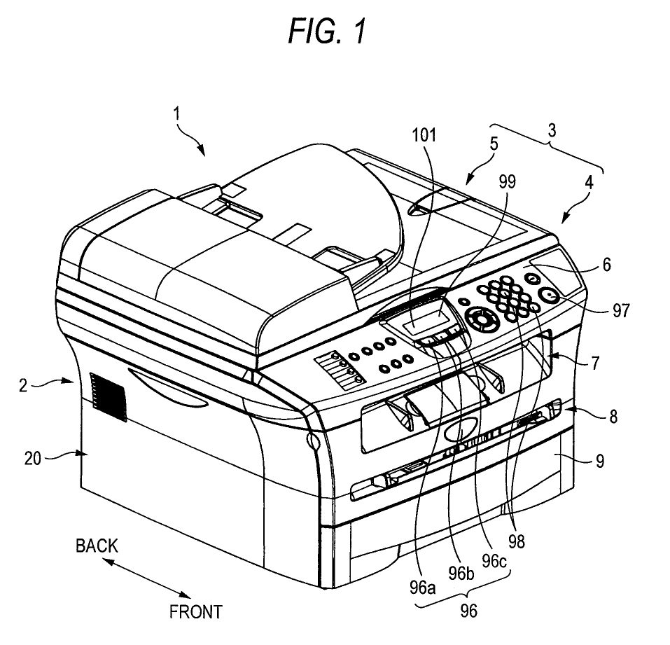

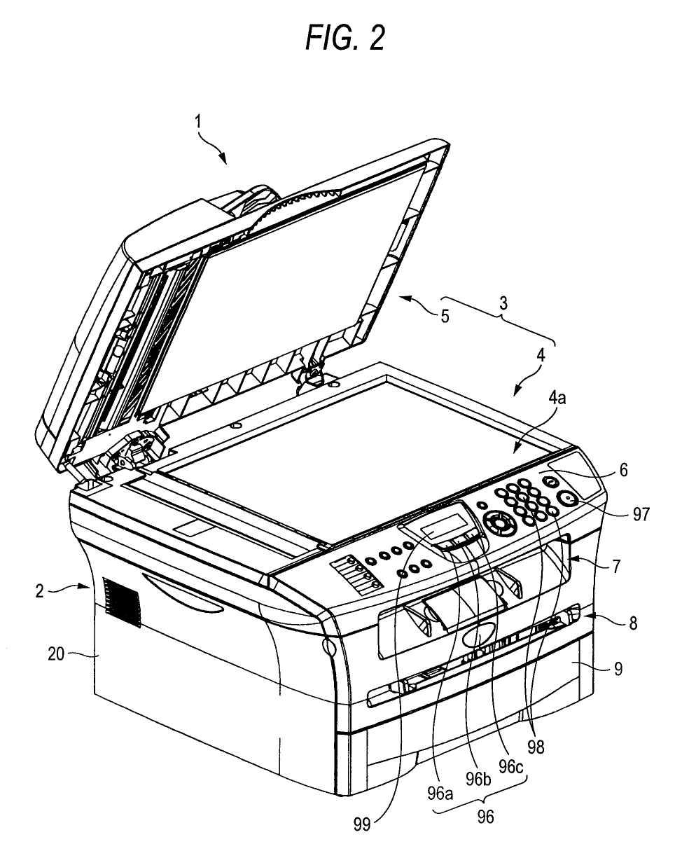

An apparatus for printing an image according to an embodiment of the present invention is a multifunction device 1 having a printer function, a scanner function, and a copier function. FIG. 1 is a perspective view showing the appearance of the multifunction device. FIG. 2 is a perspective view of the multifunction device 1 with a reading unit 3 being opened. In the following descriptions, the direction of a side of the multifunction device 1 equipped with an operation section 6 (a lower right position in a drawing sheet of FIG. 1) is taken as the “front”; and the direction of an opposite side of the multifunction device 1 (an upper left position in the drawing sheet of FIG. 1) is taken as the “back.”

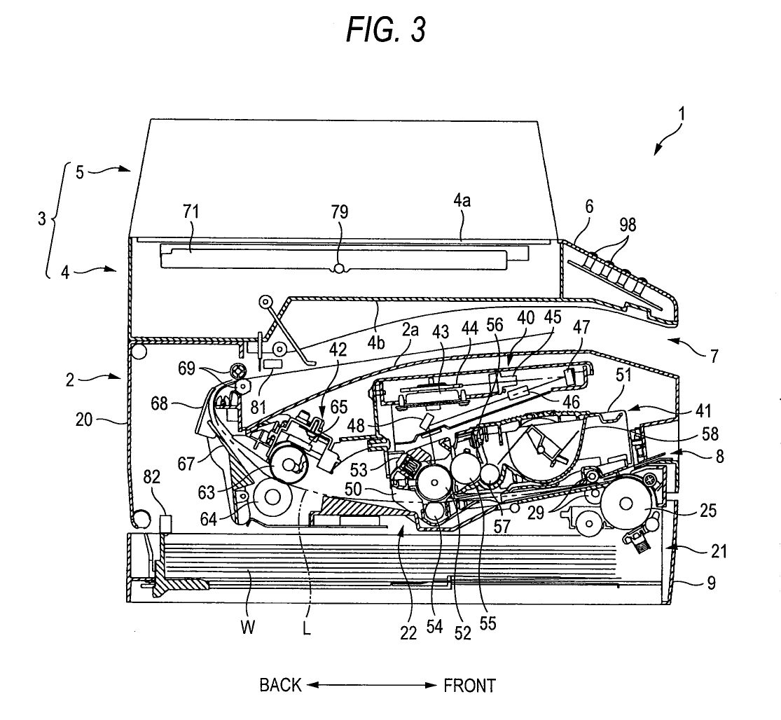

This multifunction machine 1 includes an image forming unit 2 incorporating a feeder section 21, an image forming section 22, and others (see FIG. 3); and an automatic transported-document reading unit 3 (hereinafter called an “image reading unit 3”). As shown in FIGS. 1 and 2, the image reading unit 3 includes an image reading device 4 having on top thereof a rectangular document table 4a, and an automatic document feeder (hereinafter called an “ADF 5”) disposed so as to cover the document table 4a. As shown in FIG. 2, the image reading unit 3 is supported in a pivotable manner at a rear end of an upper surface of the image forming unit 2 (i.e. an upper left position in the drawing sheet of FIG. 1). The operation section 6 which enables a user to perform various operations is provided at a front end of the upper surface of the image forming unit 2 (a lower right position in the drawing sheet of FIG. 1). The operation section 6 includes a mode selection switch 96, a start key 97, various operation buttons 98, and a liquid-crystal display touch panel 99.

The mode selection switch 96 can select any mode from three types of function modes (a mode for enabling performance of the facsimile function, a mode for enabling performance of the scanner function, and a mode for enabling performance of a copier function). Specifically, a copy mode key 96a used for selecting a copy mode, a FAX mode key 96b for selecting a FAX (facsimile) mode, and a scanner mode key 96c for selecting a scanner mode are arranged side by side.

The start key 97 is for initiating operation corresponding to a function mode. When the start key 97 is pressed (turned on) in the copy mode, copying of a document set (placed) on the document table 4a is commenced. When the start key 97 is pressed in the FAX mode or the scanner mode, operation for reading a document to be FAX-transmitted or operation for reading an image to be scanned is performed.

When a setting menu button (omitted from the drawings) is displayed through predetermined operation and when the setting menu is touched, various settings are displayed on the touch panel 99. Moreover, when an error; for instance, an error relating to the deficiency of sheets W, has arisen, an error is displayed on a display section 101 constituting a part of the touch panel 99, thereby reporting occurrence of the error to the user.

A space 7 opened in mutual communication with a sheet discharging tray 2a (FIG. 3: the tray will be described later) is formed in a position below this operation section 6. A manual sheet feeding port 8—which is opened in the shape of a slit and which extends in a horizontal direction—is provided below the space 7. Further, a sheet feeding cassette 9 is provided below the manual sheet feeding port 8.

Configurations of respective sections of image forming unit 2 will be described with reference to FIG. 3. FIG. 3 is a side cross-sectional view of the multifunction device 1 when viewed from an axial direction of a feed roller 25. The right side of the drawing sheet of the drawing corresponds to the front of the multifunction device 1, and the left side of the same corresponds to the back of the same.

The feeder section 21 for feeding the sheets W and the image forming section 22 for forming a predetermined image on the fed sheet W are incorporated in a casing 20 of the image forming unit 2. The sheet discharging tray 2 a used for retaining the sheets W—which are discharged from the image forming section 22 after images have been formed on the sheets—is disposed above the image forming section 22.

The feeder section 21 includes the sheet feeding cassette 9; a sheet pressing plate (omitted from the drawings) provided in the sheet feeding cassette 9 in a swayable manner; the feed roller 25 disposed above a leading-end edge of the sheet feeding cassette 9; and others.

The sheet feeding cassette 9 is disposed at a lower position within the casing 20 and inserted into the casing from its side facing the operation section 6; namely, the right side of the casing 20 shown in FIG. 3, in a removable manner (in an attachable and detachable manner). The sheets W are loaded in this sheet feeding cassette 9 in a stacked manner. The feed roller 25 sequentially feeds the uppermost sheet W toward a registration roller 29 along a conveyance path.

In the present embodiment, the sheets W are held in the sheet feeding cassette 9. Each of the sheets W is equipped with a non-contact tag 80, for example, a Radio Frequency Identification tag (RFID tag) that stores therein information to be described later and that transmits and receives radio waves via an antenna 130.

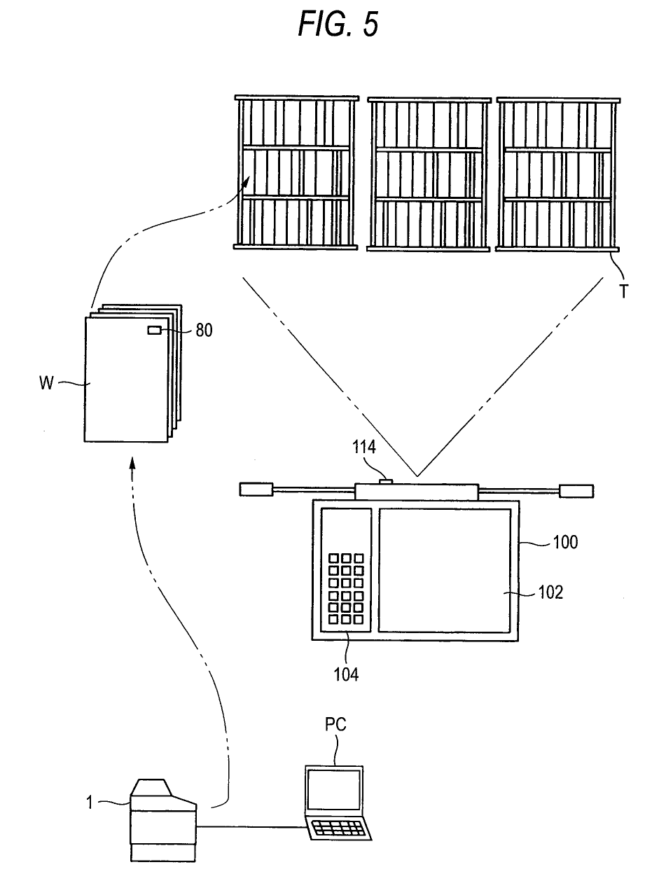

As shown in; for instance, FIG. 5, the non-contact tag 80 is embedded in a portion of margins of a rectangular sheet W (an area close to an upper right end, in the drawing, which becomes a margin at the time of printing; or an angular portion (one of four corners) of the sheet W may also be acceptable). The surface of the sheet W can be subjected to printing as is the case with an ordinary sheet.

An insertion-removal detection section 82 for detecting insertion or removal of the sheet feeding cassette 9 is disposed on either side of the trailing end of the sheet feeding cassette 9 when loaded. The insertion-removal detection section 82 is; for example, a photoelectric sensor includes a pair of elements which are disposed on both sides of the sheet feeding cassette 9; i.e., a light-emitting element (not shown) and a light-receiving element (not shown) for receiving light from the light-emitting element. When the sheet feeding cassette 9 is inserted, sidewalls of the sheet feeding cassette 9 block the light from the light-emitting element. As a result of withdrawal of the sheet feeding cassette 9, the light from the light-emitting element is received by the light-receiving element.

As a result of a signal corresponding to a change in the amount of light received by the light-receiving element being output to a CPU 90, the CPU 90 is arranged so as to be able to detect that insertion or removal (removal insertion) of the sheet feeding cassette 9 has been performed.

The registration roller 29 is formed from a pair of rollers. In accordance with detection timing of an Unillustrated position sensor disposed in the vicinity of the sheet feed roller 25, activation and deactivation of the registration roller 29 are controlled by a control circuit 83. A skew of the sheet W is corrected.

The image forming section 22 includes a scanner unit 40, a process unit 41, and a fixing unit 42. As shown in FIG. 3, the scanner unit 40 is disposed at an upper location within the casing 20 and has a laser emission section (not shown), a polygon mirror 44 rotationally driven by a polygon motor 43, lenses 45 and 46, reflection mirrors 47 and 48, and others. A laser beam which is emitted from the laser emission section and which is derived from predetermined print image data is caused to sequentially pass through or undergo reflection from the polygon mirror 44, the lens 45, the reflection mirror 47, the lens 46, and the reflection mirror 48. The laser beam is thus radiated onto the surface of a photosensitive drum 52 in the process unit 41, which will be described later, through a high-speed scan.

The multifunction device 1 includes the process unit 41 which can be attached to or removed from a main body of the image forming unit 2. The process unit 41 includes a drum cartridge 50 and a developing cartridge 51.

In the process unit 41, the drum cartridge 50 includes the photosensitive drum 52, a scorotoron-type electrification device 53, and a transfer roller 54. The developing cartridge 51 includes a developing roller 55, a layer thickness regulation blade 56, a toner feed roller 57, and a toner box 58 filled with toner (a developing agent).

The photosensitive drum 52 is disposed along and opposite the side of the developing roller 55 so as to be rotatable in a clockwise direction. The scorotoron-type electrification device 53 is for positive electrification purpose and separated from the photosensitive drum 52 with a predetermined interval so as to avoid a contact with the photosensitive drum 52.

In association with rotation of the photosensitive drum 52, the surface of the photosensitive drum 52 is uniformly electrified with positive charges by the scorotoron-type electrification device 53. Subsequently, the photosensitive drum 52 is exposed to a high-speed scan of a laser beam from the scanner unit 40, whereupon an electrostatic latent image derived from predetermined print image data is formed.

Next, when the positively-charged toner held on the developing roller 55 faces and comes into contact with the photosensitive drum 52 as a result of rotation of the developing roller 55, the toner is supplied to the electrostatic latent image produced on the surface of the photosensitive drum 52.

The transfer roller 54 is disposed beneath and opposite the photosensitive drum 52 and supported by the drum cartridge 50 so as to be rotatable in a counterclockwise direction. A visible image held on the surface of the photosensitive drum 52 is transferred onto the sheet W in the process of the sheet W passing between the photosensitive drum 52 and the transfer roller 54.

The fixing unit 42 is disposed at a down stream position (i.e., a backward position) with reference to the process unit 41 in the direction of conveyance of the sheets. The fixing unit 42 includes a heating roller 63 for heating and fusing the toner transferred on the sheet W; a pressing roller 64 which is disposed opposite the heating roller 63 and which presses the fed sheet W toward the heating roller 63; and a thermister 65.

The heating roller 63 has a constituent metal pipe serving as a cylindrical member, and a halogen lamp is fitted into the heating roller along an axial direction of the roller. This halogen lamp enables heating of the surface of the heating roller 63 up to a fixing temperature (e.g., 200° C.) at which toner is fixed to the sheet W.

The pressing roller 64 has a metal roller shaft and a rubber roller section which sheathes this pressing roller shaft and which is made of rubber material. The pressing roller 64 is resiliently pressed against the constituent metal pipe of the heating roller 63 by the rubber roller section of the pressing roller 64, to thus follow rotation of the heating roller 63.

The thermister 65 is an element whose resistance value changes according to a temperature and which measures the temperature of the heating roller 63 by the resistance value. The CPU 90 activates or deactivates the power of a heater which heats the heating roller 60 according to the thus-measured temperature, thereby controlling the heating roller 63 so as to reach a predetermined temperature.

In such a fixing unit 42, the heating roller 63 fixes the toner transferred on the sheet w in the process unit 41 by heating and pressurizing the toner in the middle of the sheet passing between the heating roller 63 and the pressing roller 64.

The heating roller 63 also conveys the image-fixed sheet W to a discharge roller 69 through the sheet discharge path formed from guide members 67 and 68. The discharge roller 69 discharges the thus-sent sheet W onto the sheet discharging tray 2a. An IC writer 81 serving as a data recording unit, which opposes the non-contact tag 80 of the sheet W sent by the discharge roller 69, is disposed in the vicinity of this discharge roller 69. The IC writer 81 can record (write) tag data into the non-contact tag 80 of the sheet n by emitting radio waves from an antenna 131.

The reading unit 3 has the image reading device 4 and the ADF 5. The image reading device 4 is disposed above the sheet discharging tray 2a of the image forming unit 2 in such a way that a lower surface 4b of the image reading device opposes and covers the sheet discharging tray 2a.

The reading unit 3 is formed as a scanner of flat bed type. In the structure of the scan of this flat bed type, when the ADF 5 is opened backwardly, the document table 4a becomes uncovered (see FIG. 2). Reading operation performed during copying or other operations can be carried out while various types of documents, such as a book, are set on the document table 4a.

Reading of a document is performed in two situations: namely, a situation where a document is subjected to reading while the document is set on the document table 4a; and another situation where a document is subjected to reading by utilization of the ADF 5. When the document is read while being set on the document table 4a, a Contact Image Sensor (CIS) 71 is moved along the document table 4a as well as along a shaft 79 extending along the direction of conveyance of a document. At that time, the document set on the document table 4a is read one line at a time. In the meantime, when the ADF 5 is utilized, the CIS 71 is moved to the left end of the document table 4a and held at that position, and the document conveyed by the ADF 5 is read on a line basis.

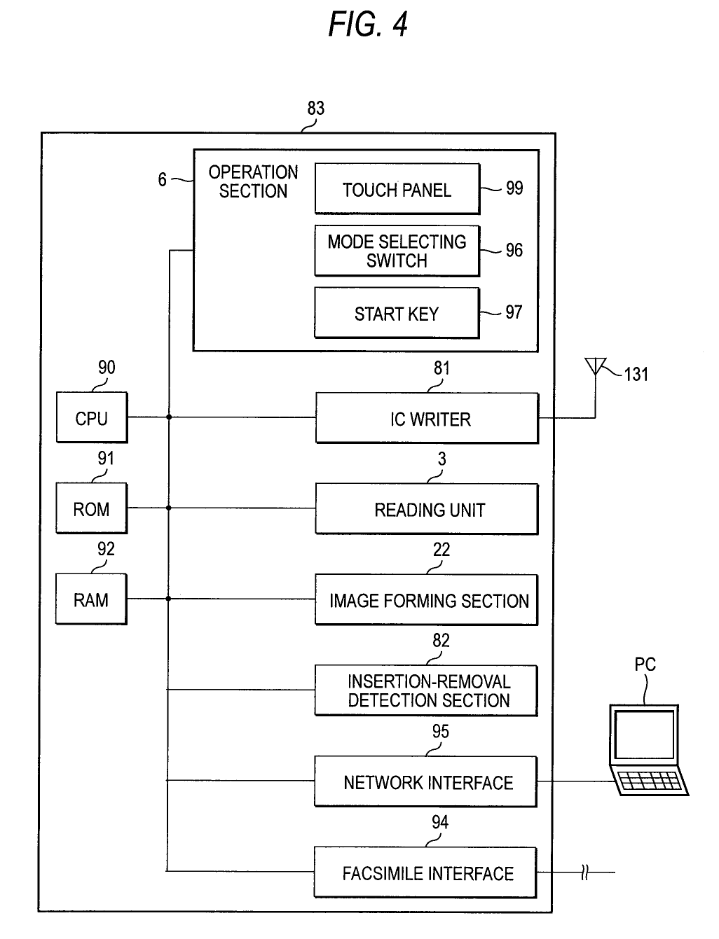

FIG. 4 is a block diagram showing an electrical system of the multifunction device 1 of the present embodiment. As shown in FIG. 4, the multifunction device 1 includes the operation section 6 for accepting various input operations; the insertion-removal section 82 for detecting insertion and removal of the sheet feeding cassette 9; the IC writer 81 for writing tag data into the non-contact tag 80 by emitting radio waves from the antenna 131; the antenna 131 connected to the IC writer 80, the reading unit 3 for reading an image; the image forming section 22 which performs printing operation and which also performs thermal fixing operations by the fixing unit 42; ROM 91; RAM 92; the CPU 90; a facsimile interface 94 connected to a communications line such as a telephone line; and a network interface 95 connected to a personal computer (hereinafter called a “PC”) or a like device.

Upon receipt of print data from an external PC or image data from the image reading unit 3 as a result of performing of scanning operation for copying purpose, print data, image data, and information (e.g., information about the user who has issued a print command or page information about the number of pages requested to be printed) attached to the data are stored into the RAM 92.

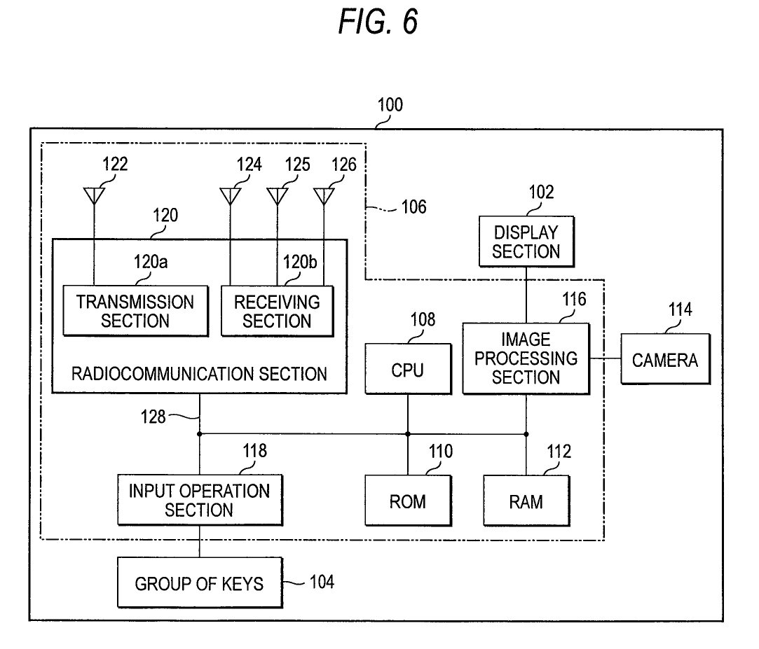

FIG. 5 is a descriptive view showing the general configuration of the printed medium management apparatus of the present embodiment. FIG. 6 is a block diagram showing an electrical system of the portable search terminal 100 of the present embodiment.]

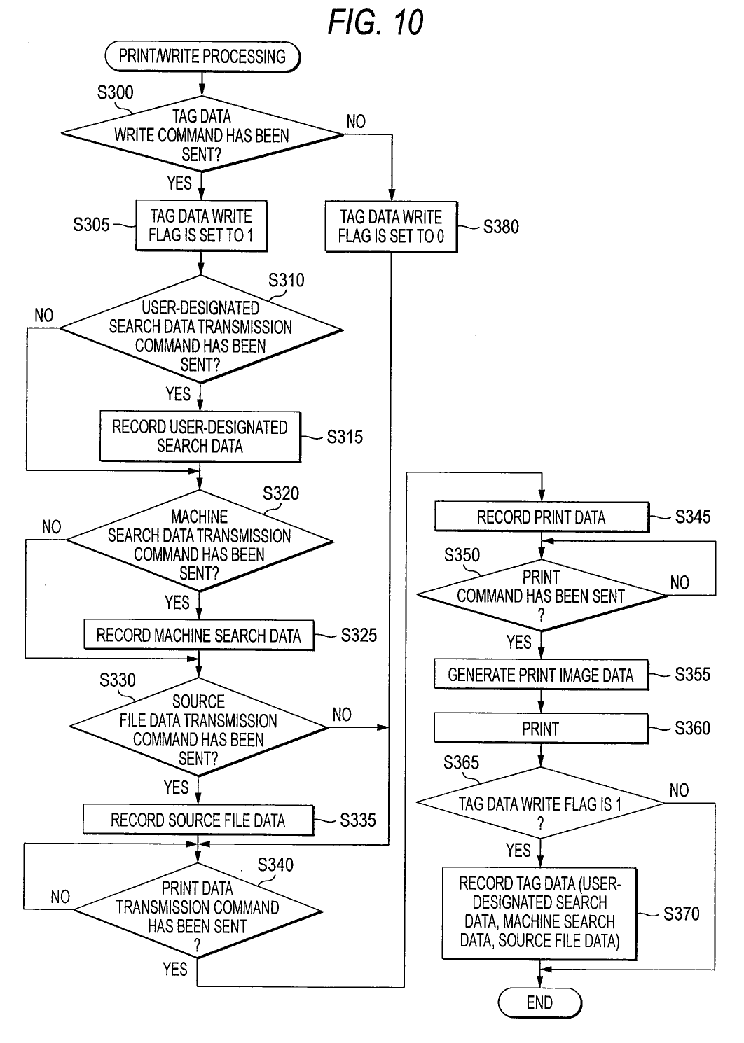

As shown in FIG. 5, the portable search terminal 100 serving as a search unit has a display section 102 for displaying an image, and the group of keys 104 for use in inputting characters, or the like, are provided at the side of the display section 102. As shown in FIG. 6, the control section 106 for electrically controlling the portable search terminal 100 includes a CPU 108 for performing control operation; ROM 110 which stores a search program (see FIG. 10) executed by the CPU 108; RAM 112 for storing tag data received from the non-contact tag 80 of the sheet W; an image processing section 116 which cause the display section 102 to display an image and which captures image data from a camera 114; an input operation section 118 connected to the group of keys 104 by which operation for inputting characters, power-on operation, and like operations, are performed; a radiocommunication section 120 which transmits and receives the tag data, or like data, stored in the non-contact tag 80 through radiocommunication; and a transmission antenna 122 and a plurality of receiving antennas 124 to 126 which are connected to the radiocommunication section 120 and which transmits or receives radio waves. The CPU 108, the ROM 110, the RAM 112, the image processing section 116, the input operation section 118, and the radiocommunication section 120 are connected to each other via a bus 128.

The radiocommunication section 120 includes a transmission section 120a for transmitting a signal to the non-contact tag 80 from the transmission antenna 122; and a receiving section 120b for receiving a signal from the non-contact tag 80 by the plurality of receiving antennas 124 to 126. The portable search terminal 100 of the present embodiment is a known terminal which repeats transmission and receipt of a signal while retaining directivity originating from the receiving antennas 124 to 126 in a single direction and gradually changing a directional angle, to thus store a received signal every time receiving operation is performed. The portable search terminal 100 determines from stored signal intensity, e.g., a direction of the directional angle in which the maximum signal intensity is achieved, as a direction in which the non-contact tag 80 is present.

The direction in which the non-contact tag 80 is present is displayed on the display section 102. For instance, the direction is captured by the camera 114, and the thus-captured image is displayed on the display section 102. Further, the direction in which the non-contact tag 80 is present is displayed on an image, and an angle of the non-contact tag 80 from the portable search terminal 100 is displayed as a numeral. The manner of the indication of the non-contact tag is not limited to the case where the direction of the non-contact tag is displayed on the display section 102. As shown in FIG. 5, when the sheet W is held in a bookshelf T, it may also be the case where a plurality of light-emitting diodes are arranged on the bookshelf T and where a light-emitting diode located close to the located non-contact tag 80 is illuminated or blinked.

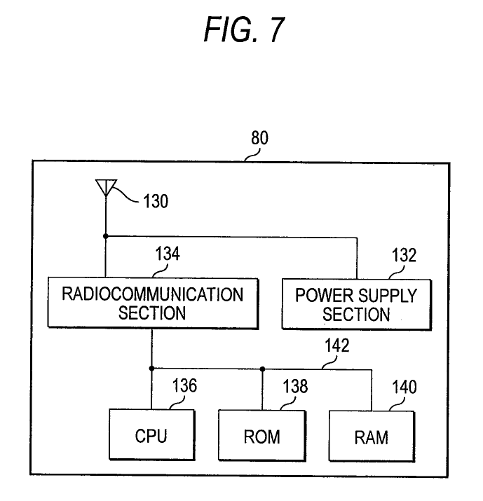

FIG. 7 is a block diagram showing an electrical system of the non-contact tag 80 of the present embodiment. As shown in FIG. 7, the non-contact tag 80 includes an antenna 130; a power supply section 132; a radiocommunication section 134; a CPU 136; ROM 138; and nonvolatile RAM 140. Each of the radiocommunication section 134, the CPU 136, the ROM 138, and the nonvolatile RAM 140 is connected to each other via a bus 142. The nonvolatile RAM 140 can store contents even when power to the RAM is shut off.

The power supply section 132 extracts power required for operation from electromagnetic waves received by the antenna 130, thereby supplying power to the respective circuits in the non-contact tag 80. The non-contact tag 80 performs radiocommunication with the IC writer 81, thereby recording tag data into the nonvolatile RAM 140.

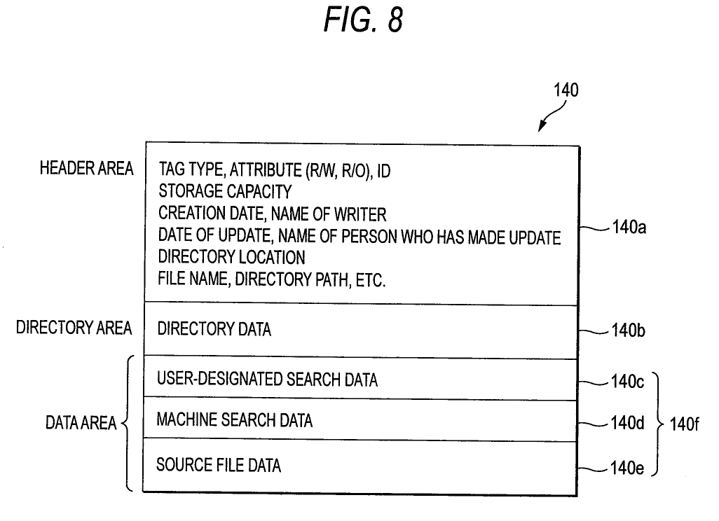

FIG. 8 is a schematic view showing a storage area of the nonvolatile RAM 140 of the non-contact tag 80 of the present embodiment. As shown in FIG. 8, the nonvolatile RAM 140 includes a header area 140a, a directory area 140b and a data area 140f. The header area 140a stores header information, such as the type of a tag, attributes (R/W, R/O), an identification number ID appended to each sheet W, storage capacity, a creation date, the name of a writer, the date of update, the name of a person who has made an update, the location of a directory, a file name, a directory path, and others. The directory area 140b stores directory data. The data area 140f includes a user-designated search data area 140c for storing user-designated search data, a machine search data area 140d for storing machine search data, and a file data area 140e for storing file data. The directory data include addresses in the nonvolatile RAM 140 used for managing the data files 140f. The directory data are for dividing the data area 140f into respective directories; namely, the user-designated search data area 140c, the machine search data area 140d, and the file data area 140e; as well as for managing the thus-divided directories.

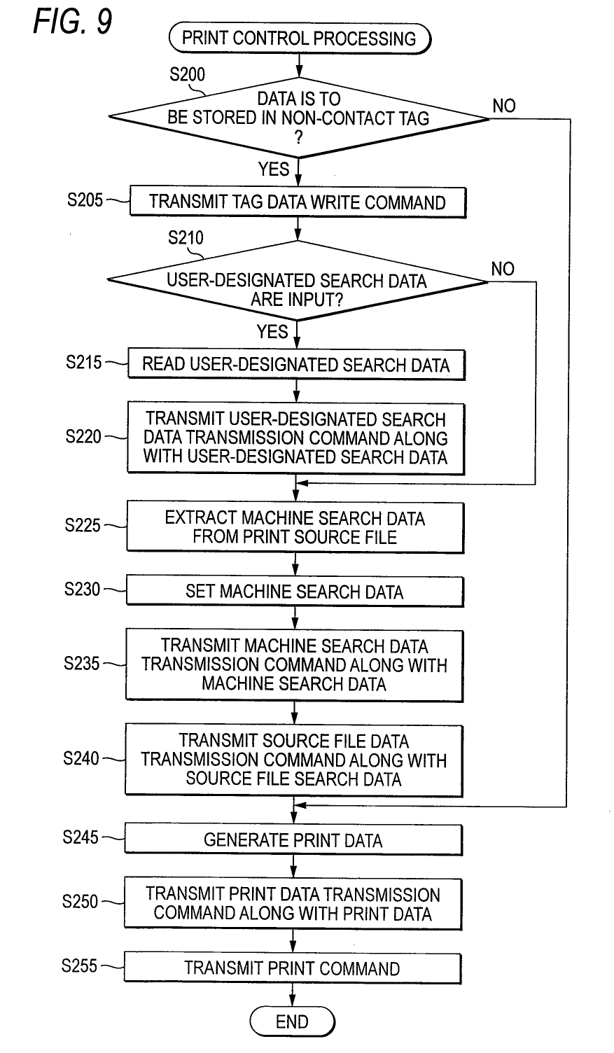

Next will be described print control processing corresponding to a print controller performed by the PC. FIG. 9 is a flowchart showing an example of print control processing performed by the PC of the present embodiment.

The print control processing is executed by a driver software previously installed in the PC. When a text edited by text edition software of the PC, a spreadsheet produced by spreadsheet software, or the like, is printed, the multifunction device 1 is selected as a printer which performs printing. When execution of printing operation is instructed, the print control processing is performed.

As shown in FIG. 9, it is determined whether or not tag data are recorded in the non-contact tag 80 (S200, hereinafter S stands for a step). In relation to a determination as to whether or not tag data are recorded, for example, a check box for making an inquiry about whether to record tag data, is displayed on the screen of the PC. When a checkmark is placed in a check box for recording tag data, recording of tag data is determined to be performed. More specifically, when a check box for recording data is marked, recording of tag data is determined to be performed (YES in S200), and a tag data write command is sent to the multifunction device 1 (S205).

Next, it is determined whether to input user-designated search data (S210). In relation to a determination as to whether or not user-designated search data are inputted, for instance, a check box for making an inquiry about whether to input user-designated search data is displayed on the screen of the PC. When a check mark is placed in a check box for inputting user-designated search data, inputting of user-designated search data is determined to be performed.

As to the user-designated search data, a search word is designated by the user who operates the PC, and user-designated search data including the search word are recorded as tag data into the non-contact tag 8. As the search word, one word or a plurality of words may be designated, and this search word may also be taken as user-designated search data. When inputting a plurality of search words, it may be preferable that the search words would be delimited by commas or spaces to create user-designated search data.

Note that the search words may include a word showing a feature of an edited text, the name of a project for which the text has been created, or a unique word such as an abbreviation of the project name. It may be better that the search words would include a word which is easy for the user to memorize or which is easily hit during search of a text.

When the check to the effect of input of user-designated search data has been made, inputting of user-designated search data is determined to be performed (YES in S210), and user-designated search data are read (S215). In connection with the user-designated search data, for instance, it may also be possible to display, on the screen of the PC, a text box into which a search word is to be input; and to read the search word input in the text box. Alternatively, it may also be possible to edit a search word by use of text edition software; to designate the name of a stored file as a text file; and to read that file.

After reading of the user-designated search data, a user-designated search data transmission command and the user-designated search data are sent to the multifunction device 1 (S220). After transmission of the user-designated search data or after the user-designated search data are determined not to be input through processing of S210 (No in S210), machine search data are extracted from a source file to be printed (S225).

A search word is extracted from the source file such as a text file edited by the PC by use of extraction software previously installed in the PC. For instance, a word which frequently appears in the text, or the like, is extracted as a search word.

After extraction of the search word, machine search data are set based on the thus-extracted search word (S230). As the machine search data, a single search word or a plurality of search words may be set. When a plurality of search words are set as the machine data, it may be preferable that the search words would be delimited by commas or spaces to create the machine search data.

After production of the machine search data, a machine search data transmission command and the machine search data are sent to the multifunction device 1 (S235). Subsequently, a source file data transmission command and source file data are sent to the multifunction machine 1 (S240). The source file data correspond to the previously-described text file edited by the PC.

After transmission of the source file data transmission command and the source file data (S240) or when tag data are not stored in the non-contact tag 80 (No in S200), the source file data are expanded, to thus generate print data to be printed by the multifunction device 1 (S245). The print data transmission command and the print data are sent to the multifunction device 1 (S250); a print command for instructing the multifunction device 1 to start printing operation is sent to the multifunction device 1 (S255); and control processing is completed.

Print/write processing performed by the multifunction device 1 will now be described. FIG. 10 is a flowchart showing example print/write processing performed by the multifunction device 1 of the present embodiment.

As shown in FIG. 10, in the multifunction device 1, it is determined whether or not the tag data write command has been sent from the PC (S300). At the time of performing the previously-described print control processing of the PC, the tag write command is determined according to whether or not the tag write command has been sent to the multifunction device 1 through processing of S205. When the tag write command has been sent (YES in S300), a tag data write flag FLAG is set to 1 (S305).

Next, it is determined whether or not the user-designated search data transmission command has been sent (S310). The user-designated search data transmission command is sent from the PC to the multifunction device 1 in processing of S220. When the user-designated search data transmission command has been sent to the multifunction device 1 (YES in S310), the user-designated search data, which are sent along with the user-designated search data transmission command through processing of S220 are stored in a buffer such as the RAM 92 (S315).

After storing the user-designated search data (S315) or after what has been sent is determined not to be the user-designated search data transmission command (NO in S310), it is determined whether or not the machine search data transmission command has been sent (S320). The machine search data transmission command is sent from the PC to the multifunction device 1 by performing processing of S235. When the machine search data transmission command has been sent to the multifunction device 1 (YES in S320), the machine search data sent along with the machine search data transmission command through processing of S235 are stored in the buffer (S325).

After storing the machine search data (S325) or after what has been sent is determined not to be the machine search data transmission command (NO in S320), it is determined whether or not the original file data transmission command has been sent (S330). The source file data transmission command is sent from the PC to the multifunction device 1 by performing processing of S240. When the source file data transmission command has been sent to the multifunction device 1 (YES in S330), the source file data sent along with the source file data transmission command through processing of S240 are stored in the buffer (s335).

After storing the source file data in the buffer (S335), after what has been sent is determined not to be the source file data transmission command (NO in S330), or after the tag data write command is determined not to be sent through processing of S300 (NO in S300), a tag data write flag FLAG is set to 0 (S380). Subsequently, it is determined whether or not the print data transmission command has been sent (S340). The print data transmission command is sent from the PC to the multifunction device 1 by performing processing of S250. When the print data transmission command has been sent to the multifunction device 1 (YES in S340), the print data sent along with the print data transmission command through processing of S250 are stored in the buffer (S345). Incidentally, when the print data transmission command is not sent (NO is s340), the multifunction device enters a standby condition while repeating processing of S340 until the print command is sent.

After storing the print data (S345), it is determined whether or not the print command has been sent (S350). The print command is sent from the PC to the multifunction device 1 by performing processing of S255. When the print command has been sent to the multifunction device 1 (YES in S350) print image data are generated from the print data (S355). The multifunction device 1 subjects the sheet W to printing based on the print image data (S360). Incidentally, when the print command is not sent (NO in S350), the multifunction device enters a standby condition while repeating processing of S350 until the print command is sent.

After printing of the sheet w (S360), it is determined whether or not the tag data write flag FLAG is 1 (s365). When the tag data write flag FLAG set through processing of S305 is 1 so that tag data are to be recorded into the non-contact tag 80 (YES in S365), the tag data are recorded in the non-contact tag 80 (S370).

After the image forming unit 2 has printed an image on the sheet W, the tag data are recorded in the non-contact tag 80 of the sheet W, which is sent to the sheet discharging tray 2a by the discharge roller 69, by the IC writer 81 through radiocommunication. At that time, the non-contact tag 80 stores the user-designated search data into the user-designated search data area 140c of the non-contact tag 80; the machine search data into the machine search data area 140d of the non-contact tag 80; and the source file data into the source file data area 140e, respectively.

When the tag data in the non-contact tag 80 are read, data can be read from each of the areas; namely, the user-designated search data area 140c, the machine search data area 140d, and the source file data area 140e. In the present embodiment, data are managed with using a tree structure of directories. Note that when reading tag data, the user-designated search data, the machine search data, and the source file data may be respectively stored as files, managed and read in a file basis in place of managing with using the directories, as long as each data are read separately.

After the tag data have been stored in the non-contact tag 80 (S370), processing ends. Further, when the tag data write flat FLAG has been set to 0 through processing of S380 (No in S365), processing ends without storing tag data.

As a result of the PC performing the above print control processing and the multifunction device 1 performing print/write processing, an image, such as a text edited by the document edition software, is printed on the sheet W, and the tag data are stored in the non-contact tag 80. For instance, the thus-produced sheet W is filed and arranged in the bookshelf T as shown in FIG. 5. The plurality of sheets W equipped with the non-contact tags 80 are placed in the bookshelf T. When a predetermined sheet W is searched from the plurality of sheets W placed in the bookshelf T, the searching is performed by operation of the portable search terminal 100.

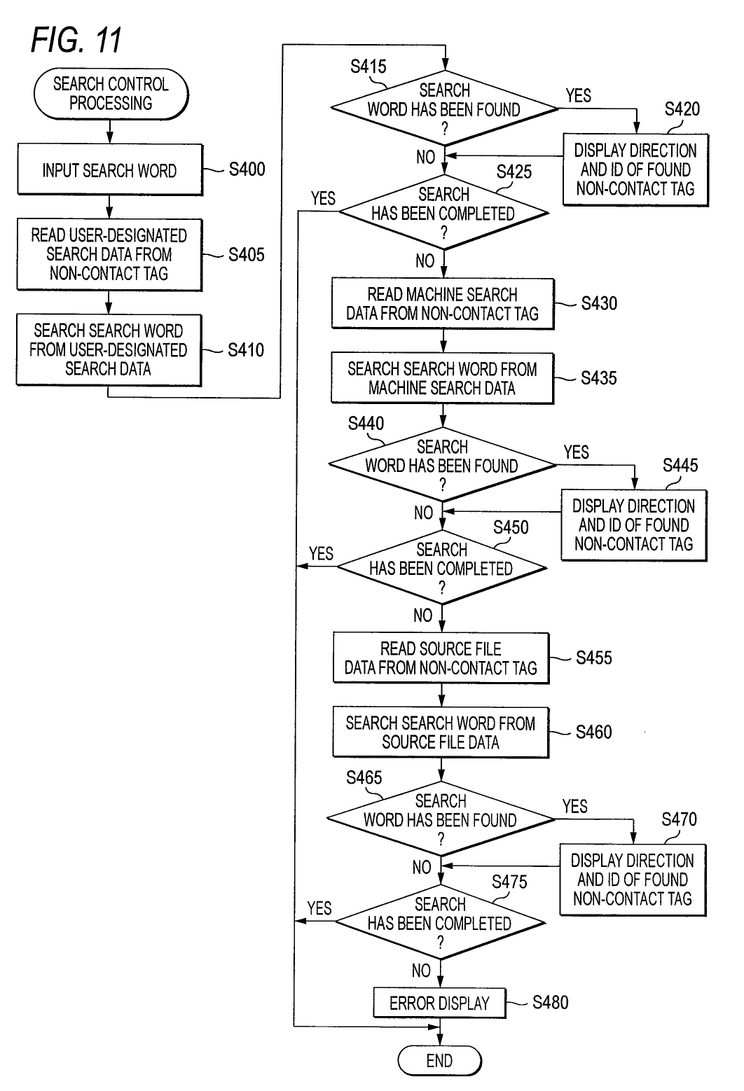

Search control processing performed by the portable search terminal 100 will now be described. FIG. 11 is a flowchart showing example search control processing performed by the search portable terminal 100 of the present embodiment.

As shown in FIG. 11, the group of keys 104 of the search portable 100 is operated, to thus input a search word relevant to a sheet W to be searched. The thus-input search word is read (S400). Next, all sets of user-designated search data stored in the respective user-designated search data areas 140c of the plurality of non-contact tags 80 placed in the bookshelf T (S405) are read, to search the input search word from among the read sets of user-designated search data (S410).

It is determined whether or not the search word has been found from among the sets based on user-designated search data through search operation (S415). When the search word has been found (YES in S415), the direction and an identification number of the non-contact tag 80 that stores the found search word are displayed on the display section 102 (S420). At that time, the bookshelf T may be photographed by the camera 114, and the image is displayed on the display section 102. Further, the position of the non-contact tag 80 may also be displayed on the image.

When the search word is not found (NO in S440) or when the direction and the identification number ID of the non-contact tag 80 have been displayed after finding the search word (S420), it is determined whether search operation ends (S425). The determination as to whether search operation ends may be based on an input from the portable search terminal 100. For instance, it may be determined based on operation of a search end button of the portable search terminal 100, and the like.

When the search ends (YES in S425), control processing ends. When the search is continued (NO in S425), all sets of machine search data stored in the respective machine search data areas 140d of the plurality of non-contact tags 80 placed in the bookshelf T are read (S430), and the search word is searched from among the sets of machine search data (5435).

Then, it is determined whether or not the search word has been found from among the sets of machine search data through search operation (S440). When the search word has been found (YES in S440), the direction and the identification number ID of the non-contact tag 80 that stores the found search word are displayed (S445).

When the search word is not found (NO in S440) or when the direction and the identification number ID of the non-contact tag 80 have been displayed after finding of the search word (S450), it is determined whether search operation ends (S450).

When the search operation ends (YES in S450), control processing ends. When the search is continued (NO in S450), all sets of source file data stored in the respective source file data areas 140e of the plurality of non-contact tags 80 placed in the bookshelf T are read (S455), and a search word is searched from among the sets of source file data (S460).

Then, it is determined whether or not the search word has been found from among the sets of source file data through search operation (8465). When the search word has been found (YES in S465), the direction and the identification number ID of the non-contact tag 80 that stores the found search word are displayed (S470). And, it is determined whether search operation ends (S475).

When the search operation ends (YES in S475), control processing ends. If not (NO in S475), an error message indicating that the corresponding search word has not been found is displayed on the display section 102 of the portable search terminal 100 (S480), and control processing ends.

As mentioned above, the user-designated search data are first read from the plurality of non-contact tags 80 at the time of search operation, thereby searching a search word from among the sets of user-designated search data. The amount of data of the user-designated search word is small. Even when the user-designated search data are read from the plurality of non-contact tags BO and searching is performed, the search word can be found within a short time period.

The machine search data are read front the plurality of non-contact tags 80, and a search word is searched from among the sets of machine search data. The amount of machine search data is small. Even when the machine search data are read from the plurality of non-contact tags 80 and when a search is performed, the search word can be found within a shorter time period. In addition, as mentioned above, searching a search word from among the sets of user-designated search data is performed prior to searching from among the sets of machine search data. Therefore, the search word can be found within a short time period.

When the search word is not found from among the user-designated search data or the machine search data, source file data are read from the plurality of non-contact tags 80, and the search word is searched from the source file data. This enables more reliable search of the search word. Even when the sheets W are worn or stained, the sheets W printed in accordance with file data can be reproduced, so long as source file data are stored in the non-contact tags 80.

Moreover, since searching can be performed with using the user-designated search data, search can be performed by a predetermined, characteristic, easy-to-memorize search word, such as a unique word. In addition, since searching can be performed with using the machine search data, a search can be performed by a search word based on contents of the source file data.

Note that although the search control processing is performed by the portable search terminal 100 in the above described embodiment, the search control processing may be performed at the multifunction device 1. In this case, a data reading unit capable of reading data from the non-contact tag 80 is provided on a sheet feeding path of the ADF 5. The tag data are read while sheets equipped with the non-contact tags 80 are fed by the ADF.

Processing of S405 to S445 corresponds to a first search unit, and processing of S455 to S470 corresponds to a second search unit.

The present invention is not limited to such embodiments and can be implemented in various modes within the scope of the gist of the invention.

What is claimed is:

1. A printed medium management apparatus comprising:
a controller that outputs print data generated from file data, and outputs tag data comprising search data including a search word;
a print unit that prints an image based on the print data on a recording medium equipped with a non-contact tag;
a data recording unit that records the tag data on the non-contact tag; and
a search unit that wirelessly communicates with a plurality of non-contact tags, on which search words are recorded by the data recording unit, to search for a non-contact tag on which an inputted search word is recorded.

2. The printed medium management apparatus according to claim 1,
wherein the tag data outputted from the controller comprises the search data and the file data.

3. The printed medium management apparatus according to claim 1,
wherein the search word included in the search data is inputted by a user.

4. The printed medium management apparatus according to claim 1,
wherein the search word included in the search data is machinery extracted from the file data.

5. The printed medium management apparatus according to claim 2,
wherein the search unit comprises:
a first search unit that searches for the non-contact tag on which the inputted search word is recorded in the search data; and
a second search unit that searches for the non-contact tag on which the inputted search word is recorded in the file data.

6. The printed medium management apparatus according to claim 5,
wherein the search word includes a first search word inputted by a user and a second search word machinery extracted from the file data, and
wherein the first search unit searches for the non-contact tag on which the inputted search word is recorded by searching a plurality of first search words recorded on the plurality of non-contact tags prior to searching a plurality of second search words recorded on the plurality of non-contact tags.

7. A computer program product embodied on a computer readable medium, which when executed by a computer, causes the computer to perform operations comprising:
inputting a first search word for file data;
machinery extracting a second search word from the file data; and
outputting the first search word and the second search word to an image forming apparatus.

8. The computer program product according to claim 7,
wherein the outputting outputs the file data.

9. An image forming apparatus comprising;
a communication unit that receives file data, a first search word inputted by a user and a second search word machinery extracted from the file data;
an image forming unit that forms an image based on the file data on a recording medium equipped with a non-contact tag; and
a data recording unit that records the first search word and the second search word on the non-contact tag.

10. The image forming apparatus according to claim 9,
wherein the data recording unit records the file data on the non-contact tag.
